(19) United States
(12) Patent Application Publication
(10) Pub. No.: US 2012/0292405 A1
(43) Pub. Date: Nov. 22, 2012

(54) APPARATUS AND METHOD FOR JETTING LIQUID MATERIAL IN DESIRED PATTERNS

(75) Inventors: Steve Clark, Cumming, GA (US); John M. Riney, Buford, GA (US); Daniel T. Smulders, Cumming, GA (US); Edward C. Taylor, Cumming, GA (US)

(73) Assignee: NORDSON CORPORATION, Westlake, OH (US)

(21) Appl. No.: 13/516,037

(22) PCT Filed: Jan. 7, 2011
(86) PCT No.: PCT/US11/20474

§ 371 Date: Jul. 27, 2012

Related U.S. Application Data
(60) Provisional application No. 61/294,951, filed on Jan. 14, 2010.

(51) Int. Cl. B05B 1/28

(52) U.S. Cl. 239/291

(57) ABSTRACT

An apparatus 10 for jetting liquid material in desired patterns includes a jetting module 18 that is couplable to a source of liquid material 12. A piston 46 is disposed for movement within an interior chamber 42 to rapidly develop high pressure within the module 18 so that liquid material 12 is jetted from through a pattern plate 70 in a desired pattern.

### CROSS-REFERENCE

The application claims the benefit of priority of U.S. Provisional Patent Application Ser. No. 61/294,951, filed Jan. 14, 2010 (pending), the disclosure of which is hereby incorporated by reference herein in its entirety

### TECHNICAL FIELD

The present invention relates generally to apparatus and methods for dispensing liquid materials, and more particularly to apparatus and methods for jetting highly viscous liquids in desired patterns.

### BACKGROUND

Liquid dispensers for jetting fluids such as solder flux, conformal coatings, encapsulants, underfill material, and surface mount adhesives, are known in the art and generally operate to dispense small volumes of liquid material to a substrate by rapidly contacting a valve seat with a valve member to create a distinct, high pressure pulse that ejects a small volume of liquid from the dispenser. As used herein, liquid material jetting refers to rapidly ejecting a discrete mass of liquid material at a high velocity from a dispenser. Jetting is contrasted with extrusion wherein liquid material is dispensed as a continuous, elongate filament, generally referred to as a “bead” of adhesive. While drops can be formed by rapidly opening and closing a valve during extrusion of liquid material, or by using air to break up an extruded bead as it is dispensed, these processes are distinctly different from jetting processes wherein the discrete liquid mass is rapidly ejected directly from the dispenser at a high velocity.

FIGS. 1A and 1B illustrate the operation of a conventional jetting dispenser 10. In FIG. 1A, a valve member 12 is rapidly moved through a fluid channel 14 in the direction of a valve seat 16 having an outlet 18. As the valve member 12 approaches the valve seat 16, liquid material 20 within the channel 14 flows around the valve tip 12a. FIG. 1B depicts the jetting dispenser 10 at the instant the valve tip 12a contacts valve seat 16. The momentum of the impact between valve member 12 and valve seat 16 generates a pressure pulse that causes a small volume of liquid 20a to be ejected through the outlet 18. U.S. Pat. No. 5,747,102 to Smith et al. and U.S. Pat. No. 6,253,957 to Messerly et al., both assigned to the assignee of the present application, are directed to jetting dispensers.

Conventional jetting dispensers require precise timing control to ensure that a consistent volume of liquid material is jetted from the dispenser. For example, if the valve timing is too fast, there is insufficient time for liquid material to refill within the dispenser, resulting in a lower than desired volume of liquid dispensed. Likewise, if the timing is too slow, the resulting volume of liquid is higher than desired. It has long been thought that hot melt adhesive could not be adequately dispensed by a jetting dispenser, due to the high viscosity of hot melt adhesives and the differences in general rheology between hot melt adhesives and liquid materials that have been conventionally used in jetting processes. Accordingly, hot melt adhesive have generally been dispensed by dedicated hot melt adhesive dispensing systems that utilize high pressure to supply adhesive to a dispensing module. Typical pressures are in the range of 400 psi to 1000 psi. A valve within the dispensing module is opened and closed to regulate the flow of the highly pressurized hot melt adhesive through an outlet nozzle.

Conventional jetting dispensers are also generally configured to jet liquid material as individual droplets. In certain applications, it may be desired to dispense liquid material, particularly a highly viscous liquid material such as hot melt adhesive, in a particular pattern. Accordingly, there is a need for methods and apparatus for dispensing highly viscous materials, such as hot melt adhesive, in discrete, small volumes and in desired patterns, and which overcome these and other drawbacks of conventional dispensing systems.

### SUMMARY

The present invention overcomes the foregoing and other shortcomings and drawbacks of dispensing systems heretofore known for use in dispensing small, discrete volumes of liquid material, particularly highly viscous liquid material such as hot melt adhesive, in a desired pattern. While the invention will be described in connection with certain embodiments, it will be understood that the invention is not limited to these embodiments. On the contrary, the invention includes all alternatives, modifications and equivalents as may be included within the scope of the present invention.

In another aspect, an apparatus for jetting liquid material includes a jetting module that is couplable to a source of liquid material and an interior chamber within the module for receiving liquid material from the source. A pattern plate is in fluid communication with the interior chamber and has at least one outlet for jetting liquid material in a desired pattern. A piston disposed within the interior chamber is movable from a position wherein liquid material is admitted into the interior chamber, then rapidly to a second position wherein high pressure is developed proximate the piston to cause a discrete volume of liquid material to be jetted from the pattern plate through the outlet.

In another aspect, an apparatus for jetting liquid material includes a jetting module having a liquid chamber that is couplable to a source of liquid material. A piston having a piston tip is movably disposed within the liquid chamber. A recess communicating with the liquid chamber and a liquid passageway has a shape that is complimentary to the shape of the piston tip, whereby the piston tip may be received in the recess. The piston is movable from a position wherein the piston tip is spaced from the recess, to a position wherein the piston tip effectively seals off the recess, then to a position wherein the piston tip is received within the recess to displace a discrete volume of liquid material from the recess and through the passageway. The apparatus further includes a pattern plate having at least one liquid outlet in communication with the passageway to jet liquid material in a desired pattern.

The above and other objects and advantages of the present invention shall be made apparent from the accompanying drawings and the description thereof.

### DESCRIPTION OF FIGURES

FIGS. 1A and 1B illustrate operation of a conventional jetting dispenser.

FIG. 2 is a perspective view of an exemplary jetting dispenser for jetting viscous liquids in desired patterns.

FIG. 3 is a partial cross-sectional elevation view of the jetting dispenser of FIG. 2.

FIG. 4 is an exploded perspective view of a jetting module of the jetting dispenser of FIG. 2.

FIG. 5 is an exploded perspective view of the nozzle assembly and pattern plate of FIG. 4.

FIGS. 6A-6D are partial cross-sectional views of the jetting module of FIG. 3, illustrating operation of the jetting dispenser.

FIG. 7 is a partial cross-sectional view of another jetting module, similar to the jetting module depicted in FIG. 2.

FIG. 8 is a partial exploded view of another exemplary jetting module, similar to the jetting module of FIG. 7.

FIG. 9 is a partial cross-sectional view of another exemplary jetting module in accordance with the present disclosure.

FIG. 10 is a partial cross-sectional view of the jetting module of FIG. 9.

FIG. 11 is a partial cross-sectional view of the jetting module of FIG. 8 with another pattern plate.

FIG. 12 is a perspective view of an exemplary nozzle for jetting liquid material in a desired pattern.

FIG. 13 is a cross-sectional view of the jetting nozzle of FIG. 12.

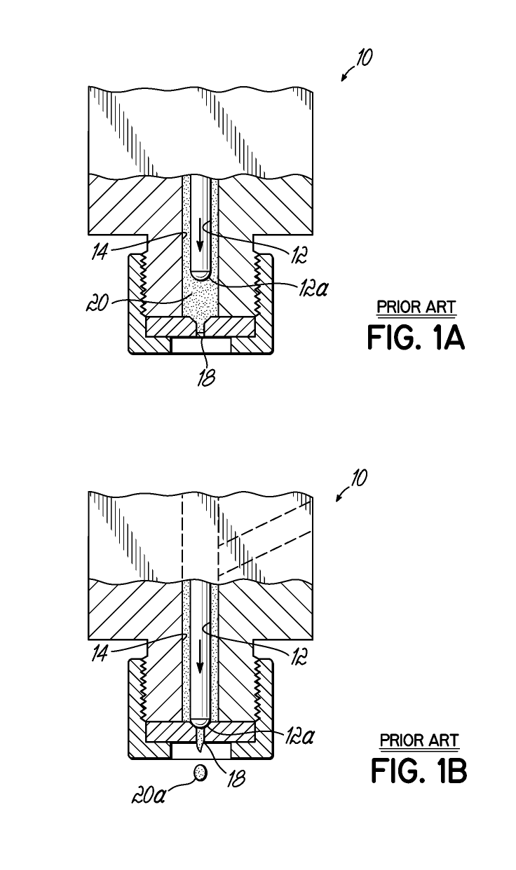

### DETAILED DESCRIPTION

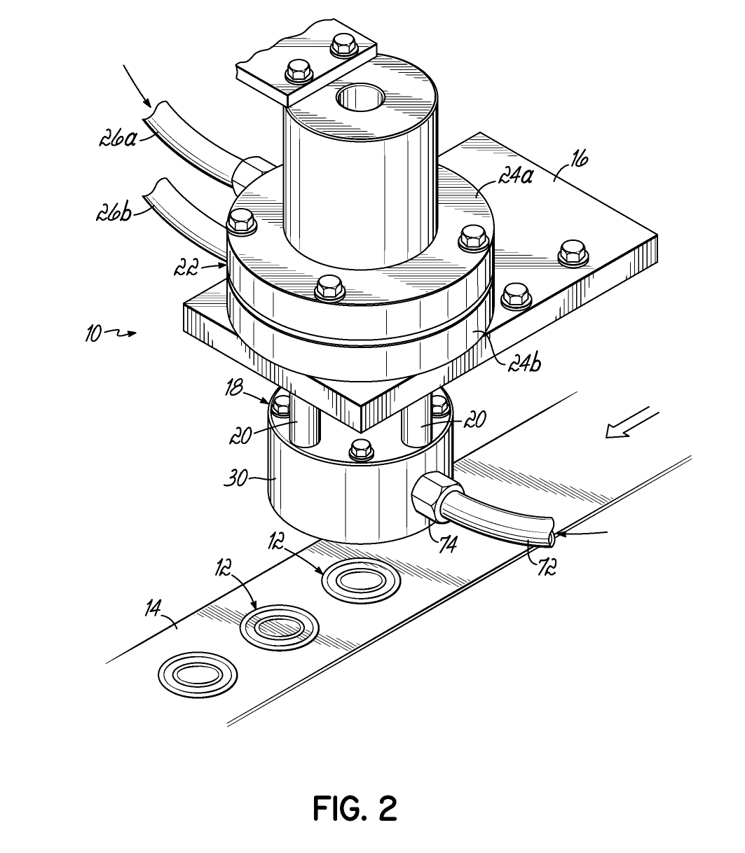

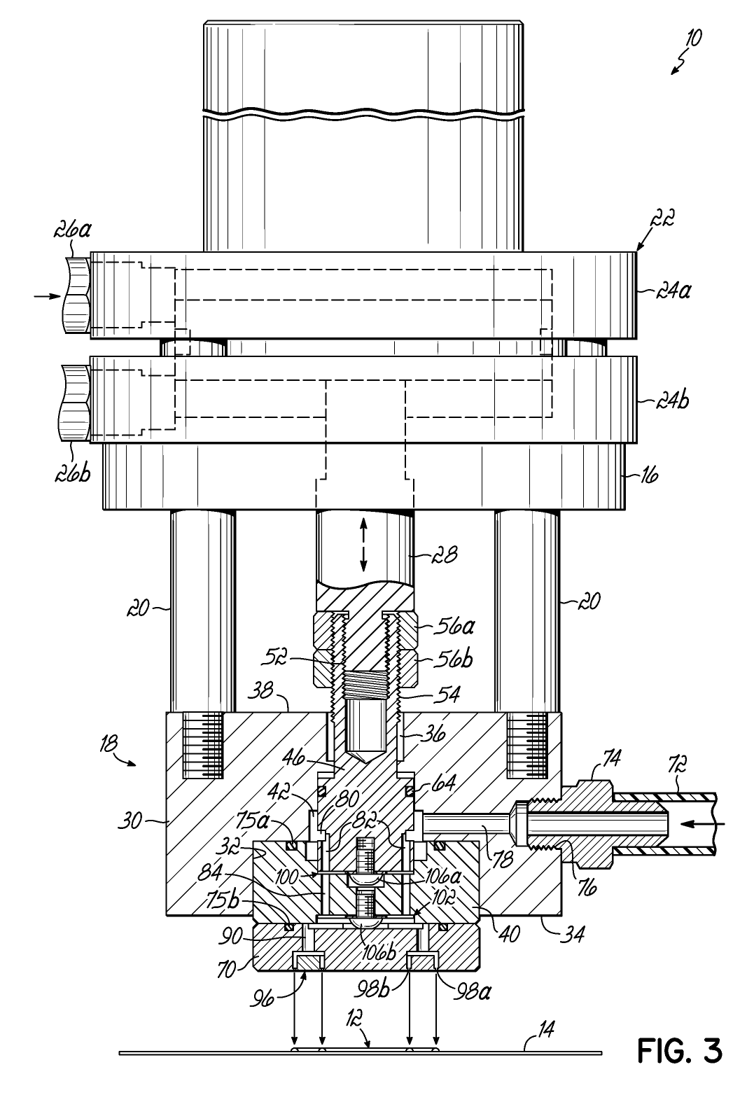

FIGS. 2-3 depict an exemplary jetting dispenser 10 in accordance with the present disclosure for dispensing highly viscous material 12, such as hot melt adhesive, in desired patterns to a substrate 14 moving beneath the dispenser 10. For example, the jetting dispenser 10 may be used to dispense material having viscosities in the range of about 100 cps to about 20,000 cps. In another aspect, the jetting dispenser 10 may be used to dispense material having viscosities in the range of about 100 cps to about 25,000 cps. The dispenser 10 is located a distance above the substrate 14 by a suitable support structure 16. While support structure 16 is shown herein as including simple frame-like components, it will be appreciated that various other structure could alternatively be used to support dispenser 10, including movable structure such as a robotic manipulator, for example. In the embodiment shown in FIG. 2, the jetting dispenser 10 includes a jetting module 18 that may be attached to the support structure 16 by a plurality of support rods 20. The dispenser 10 may further include a pneumatic supply 22 for supplying pressurized air to the jetting module 18. The pneumatic supply 22 may include first and second manifolds 24a, 24b coupled to respective air lines 26a, 26b for rapidly actuating an actuator rod 28 for movement into and out of the pneumatic supply 22.

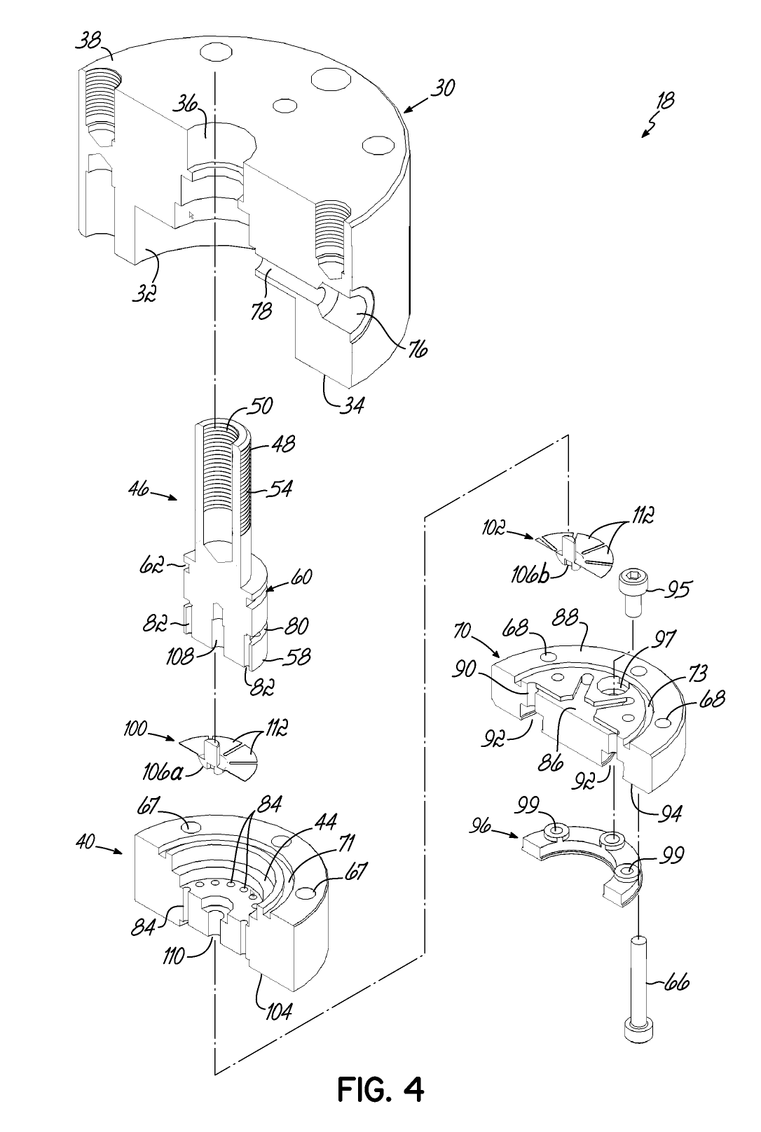

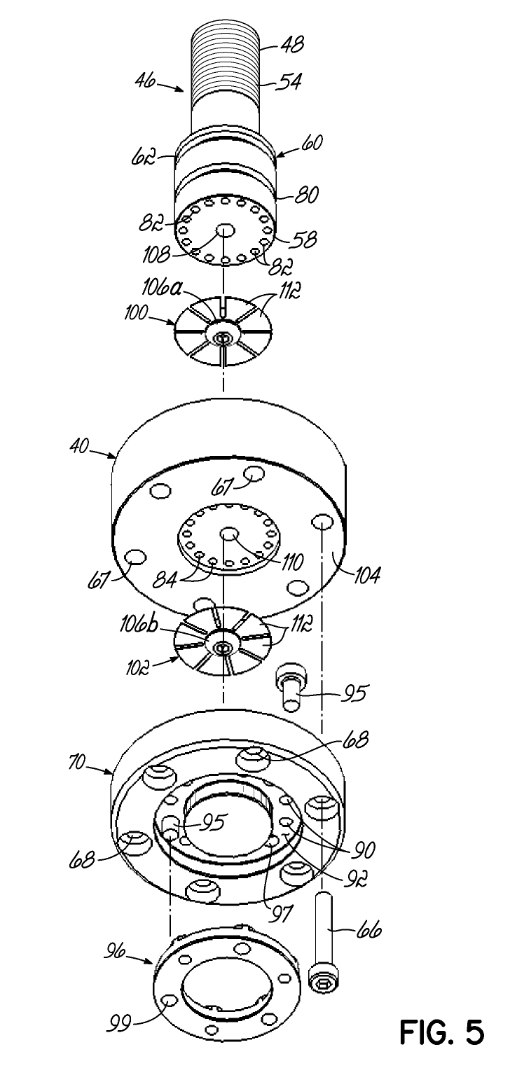

With continued reference to FIGS. 2-3, and referring further to FIGS. 4-5, the jetting module 18 comprises a housing 30 having a centrally located recess 32 formed on a first end 34 thereof, and an aperture 36 formed through the second end 38 and communicating with the recess 32. The recess 32 is configured to receive a nozzle body 40 at least partially therein to define an interior chamber 42 between the recess 32 formed in the first end 34 of the housing 30 and corresponding recess 44 formed in the nozzle body 40. A piston 46 is disposed within the interior chamber 42 and has a first end 48 extending through the aperture 36 in the housing 30. The first end 48 of the piston 46 includes a threaded bore 50 adapted to receive and engage corresponding threads 52 formed on the actuator rod 20 of the pneumatic supply 22. The exterior surface 54 of the first end 48 of the piston 46 is also threaded to receive first and second nuts 56a, 56b thereon for limiting the displacement of the second end 58 of the piston 46 within the chamber 42, as will be described more fully below.

The second end 58 of the piston 46 defines a generally cylindrical piston head 60 configured to fit closely within the chamber 42 defined by the housing recess 32 and the nozzle recess 44. An O-ring groove 62 formed on the piston head 60 supports an O-ring 64 for sealingly engaging a portion of the housing recess 32 to prevent fluid communication from the interior chamber 42 through the aperture 36 in the housing 30. The jetting module 18 further includes a pattern plate 70 coupled to the nozzle body 40. Liquid material received in the interior chamber 42 of the jetting module 18 is displaced from the interior chamber 42 through the nozzle body 40 and pattern plate 70, as will be described more fully below.

In the embodiment shown, nozzle body 40 and pattern plate 70 are coupled to the housing 30 by fasteners 66 received through apertures 67 in the nozzle body and apertures 68 in the pattern plate 70. A circumferential groove 71 in the nozzle body 40 supports an O-ring 75a for sealing between the nozzle body 40 and the housing 30. Similarly, a circumferential groove 73 in the pattern plate 70 supports an O-ring 75b for sealing between the pattern plate 70 and the nozzle body 40.

Referring to FIGS. 3-5, liquid material is supplied to the interior chamber 42 from a source (not shown) through a low pressure conduit 72 that is coupled to the housing 30 by an appropriate fitting 74 received in a housing inlet 76. As a non-limiting example, low pressure conduit 72 may be configured to accommodate pressures in the range of about 5 psi to about 40 psi, or in other pressure ranges suitable for providing liquid material to the interior chamber 42. The inlet 76 is in fluid communication with the interior chamber 42 via an inlet passage 78. The liquid material is provided from the supply at a pressure sufficient to fill the interior chamber 42 defined by the housing recess 32 and the nozzle body recess 44. A circumferential groove 80 formed in the piston head 60 communicates with a plurality of liquid passageways 82 formed through the piston head 60 and a plurality of nozzle passageways 84 formed through the nozzle body 40 to a distribution channel 86 formed in a first side 88 of the pattern plate 70. The distribution channel 86 defines radially extending paths communicating with respective outlet passageways 90 through the pattern plate 70 and communicating with an annular recess 92 formed into the second side 94 of the pattern plate 70. A ring insert 96 coupled to the second side 94 of the pattern plate 70 is received within the annular recess 92 to define an outer annular outlet 98a and an inner annular outlet 98b on the second side 94 of the pattern plate 70, through which liquid material 12 is jetted to form a concentric ring-shaped pattern on the substrate 14. The ring insert is coupled to the pattern plate by fasteners 95 received through apertures 97, 99 in the pattern plate 70 and ring insert 96, respectively.

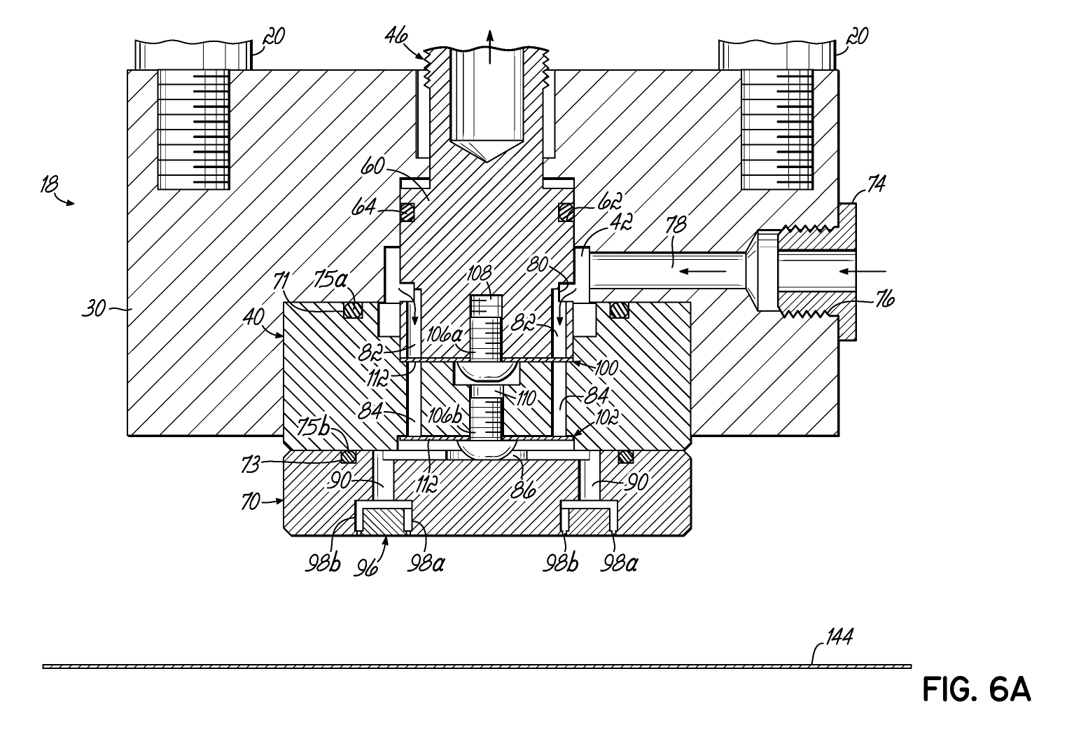

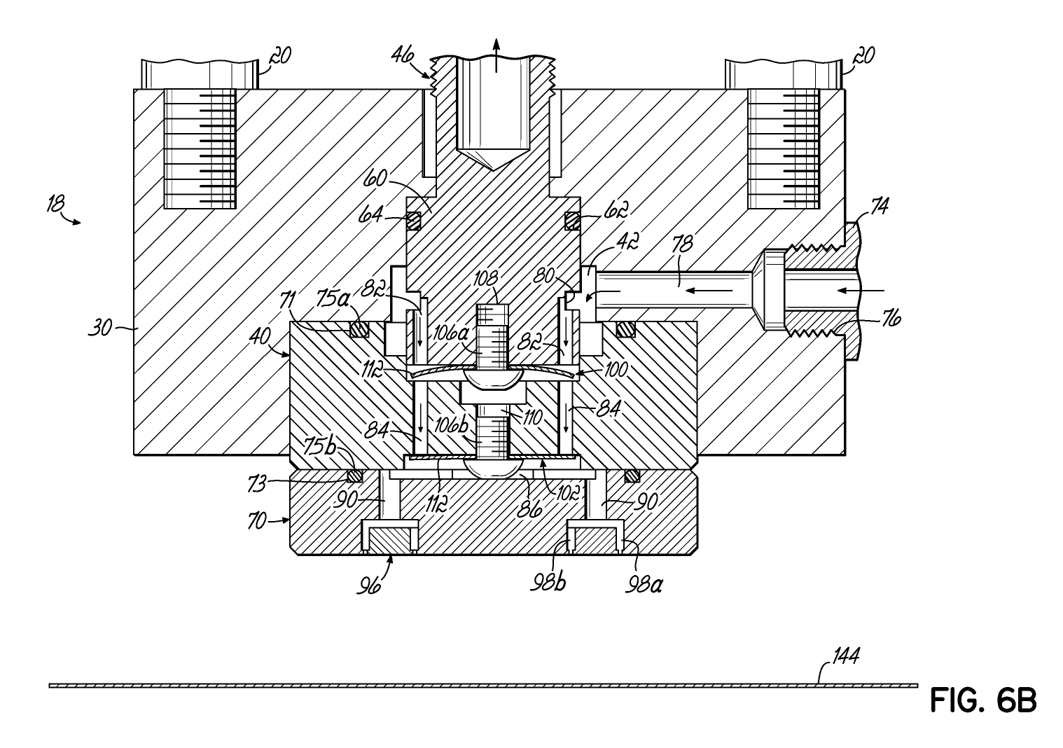

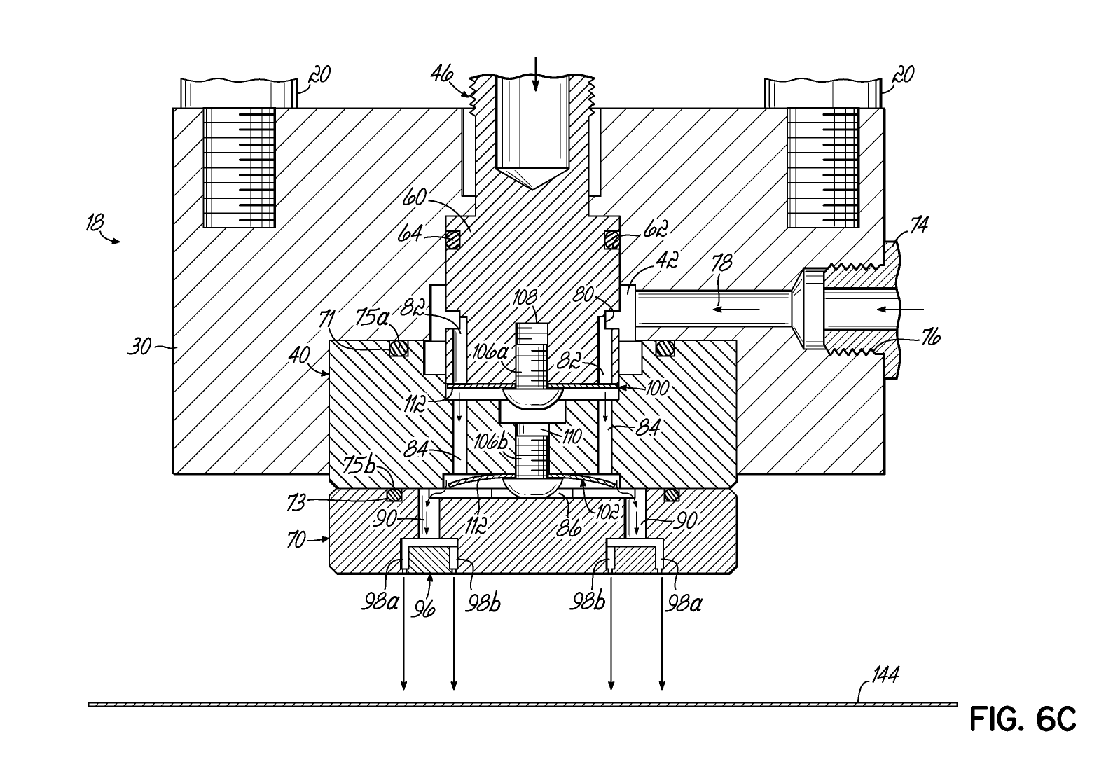

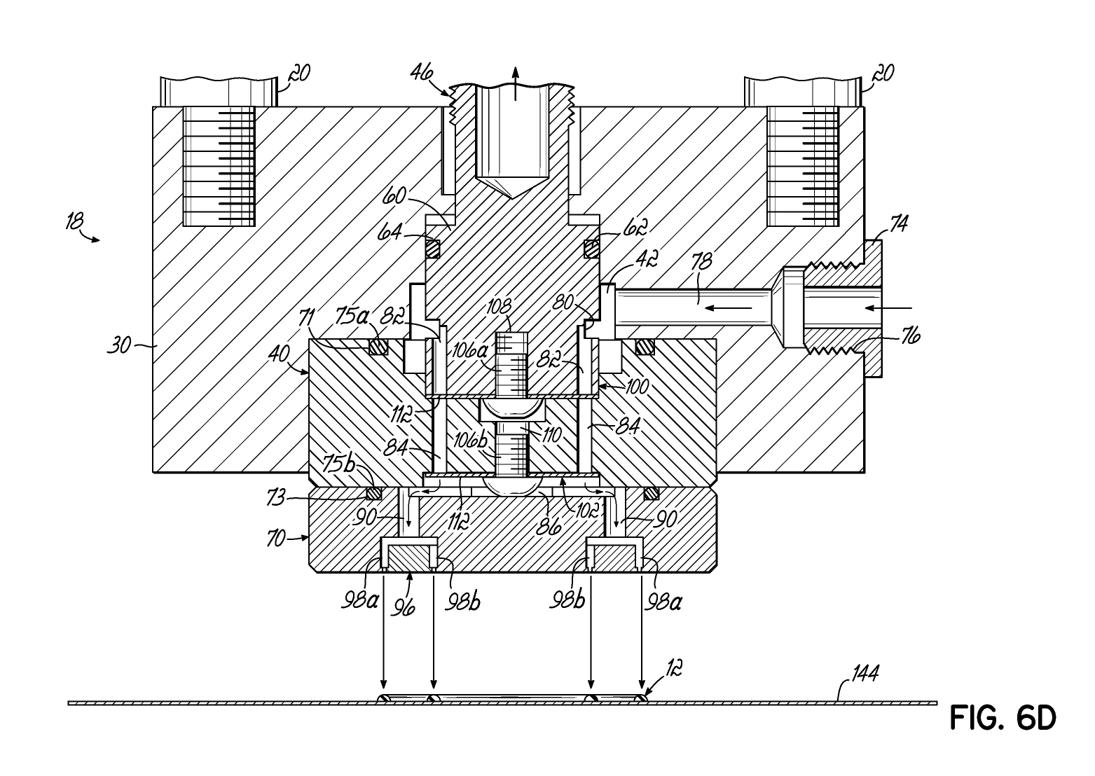

The jetting module 18 further includes a first reed valve 100 coupled to the second end 58 of the piston 46, and a second reed valve 102 coupled to the second side 104 of the nozzle body 40, to control the movement of liquid material 12 through the jetting module 18. The first reed valve 100 is coupled to the piston 46 by a threaded fastener 106a received in a corresponding threaded aperture 108 formed through the second end 58 of the piston 46. Similarly, the second reed valve 102 is secured to the nozzle body 40 by a threaded fastener 106b received through a central threaded aperture 110 in the nozzle body 40. The first and second reed valves 100, 102 comprise a plurality of lobes 112 extending radially outwardly to cover the liquid passageways 82 formed in the piston head 60 and the nozzle passageways 84 formed in the nozzle body 40, as will be described with reference to FIGS. 6A-6D to illustrate operation of the jetting module 18.

With reference to FIGS. 3 and 6A, liquid material has been provided from the source through the housing inlet 76 and inlet passage 78 to the interior chamber 42 defined by the housing recess 32 and nozzle body recess 44. After the dispenser 10 has been operated through several cycles to move the piston 46 within the chamber 42, the jetting module 18 will be primed with liquid material throughout the passages of the nozzle body 40 and pattern plate 70. Pressurized air is provided to the lines 26a, 26b of the pneumatic supply 22 (FIG. 2) to drive the actuator rod 28 in a direction that retracts the piston 46 from an extended position illustrated in FIG. 6A to a retracted position illustrated in FIG. 6B. As a result of this displacement, liquid material in the interior chamber 42 is forced through the liquid passageways 82 of the piston head 60, deflecting the lobes 112 of the first reed valve 100 and filling nozzle passages 84, as depicted in FIG. 6B. The lobes 112 of the second reed valve 102 remain in contact with the nozzle body 40 to prevent the backflow of liquid material from the distribution channel 86 and outlet passageways 90 as the piston 46 is moved in a direction toward the pneumatic supply 22.

Pressurized air is then provided to the pneumatic supply 22 to move the piston 46 in a direction toward the nozzle body 40. As the piston 46 begins to move toward the nozzle body 40, the lobes 112 of the first reed valve 100 are closed over the liquid passageways 82 and remain in contact with the first end 58 of the piston 46 to prevent the backflow of liquid material through the liquid passageways 82 of the piston head 60. Movement of the piston head 60 toward the nozzle body 40 forces liquid through the nozzle passages 84 to deflect the lobes 112 of the second reed valve 102, whereby liquid material is forced into the distribution channel 86, through the outlet passageways 90 and the annular recess 92 formed in the second side 94 of the pattern plate 70, to be dispensed through the outer and inner annular outlets 98a, 98b formed by the ring insert 96 coupled to the pattern plate 70. Movement of the piston head 60 toward the nozzle body 40 is such that a high pressure is rapidly developed in the chamber 42 and a discrete volume of liquid material 12 is jetted from the outer and inner annular outlets 98a, 98b in the pattern plate 70 to form a concentric ring-shaped pattern on the substrate 14, as depicted in FIG. 6D. In one embodiment, the pressure developed in chamber 42 may be in the range of about 400 psi to about 2500 psi.

While the piston 46 may be driven by the actuator rod 28 to move throughout the entire stroke permitted by the relative dimensions of the interior chamber 42, the stroke of the piston 46 may alternatively be limited by adjusting the first and second nuts 56a, 56b threaded to the first end 48 of the piston 46, whereby the volume of liquid material dispensed by the jetting dispenser 10 may be selectively adjusted.

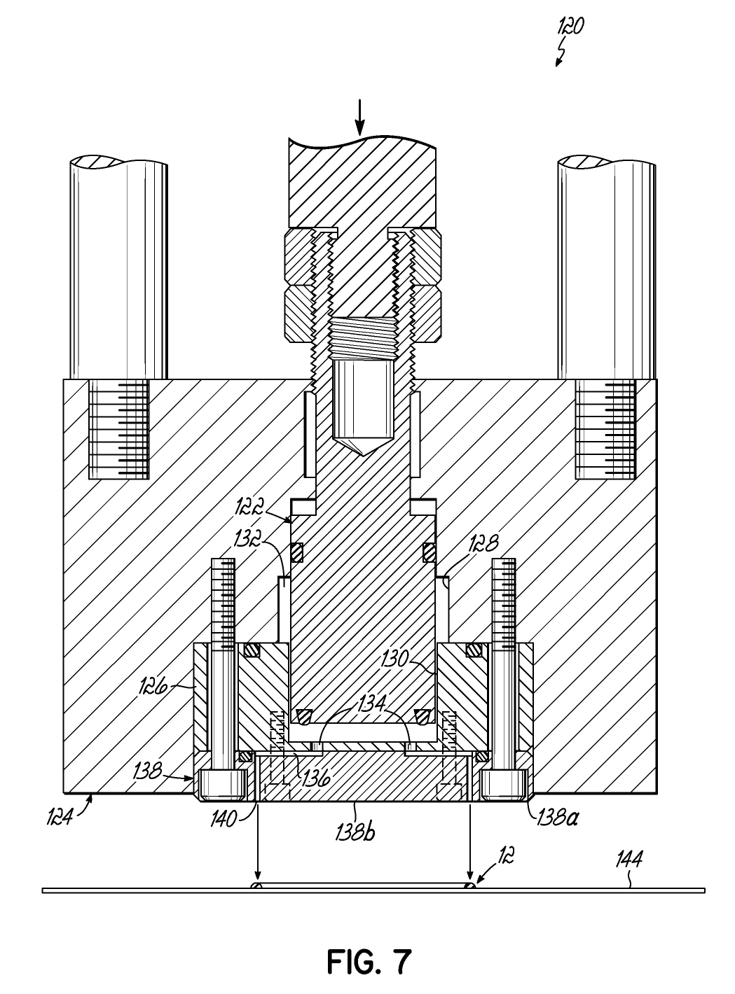

FIG. 7 depicts another exemplary jetting module 120, similar to the jetting module 10 of FIG. 3, wherein the piston 122 does not include reed valves to control the flow of liquid material. The module 120 includes a housing 124 and a nozzle body 126, each having respective recesses 128, 130 defining an interior chamber 132 when the nozzle body 126 is coupled to the housing 124. Nozzle passages 134 in the nozzle body 126 communicate with a radial passage 136 defined between the nozzle body 126 and a pattern plate 138. In this embodiment, the pattern plate 138 defines a single annular outlet 140 through which liquid material 142 is jetted to form a single ring-shaped pattern on the substrate 144 as the piston 122 is rapidly moved in a direction toward to the nozzle body 126, in a manner similar to that described above. The pattern plate 138 comprises an outer plate portion 138a and an inner plate portion 138b secured to nozzle body 126 by fasteners 146a, 146b to form the annular outlet 140.

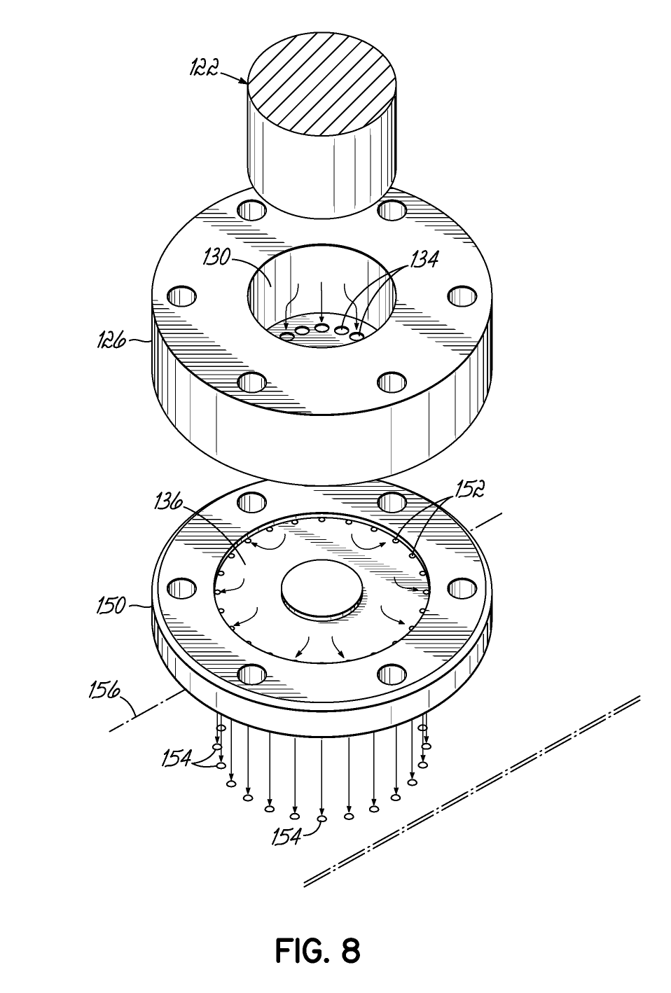

FIG. 8 depicts an exploded perspective view of nozzle body 126 together with another exemplary a pattern plate 150, similar to the pattern plate 138 depicted in FIG. 7. In this embodiment, the pattern plate 150 comprises a plurality of outlet passageways 152 formed through the pattern plate 150 for communication with the radial passage 136 defined between the pattern plate 150 and the nozzle body 126 such that liquid material is jetted as a plurality of discrete drops 154 in the desired pattern. After the drops 154 have been received on the substrate 156, the drops 154 may remain as distinct volumes of liquid material, or alternatively may coalesce to form the desired pattern. While the embodiments shown and described with reference to FIGS. 2-8 depict embodiments wherein the pattern jetted to the substrate is in the shape of circular rings, it will be appreciated that liquid material may be jetted in various other shapes, as may be desired, by appropriate modification of the pattern plates.

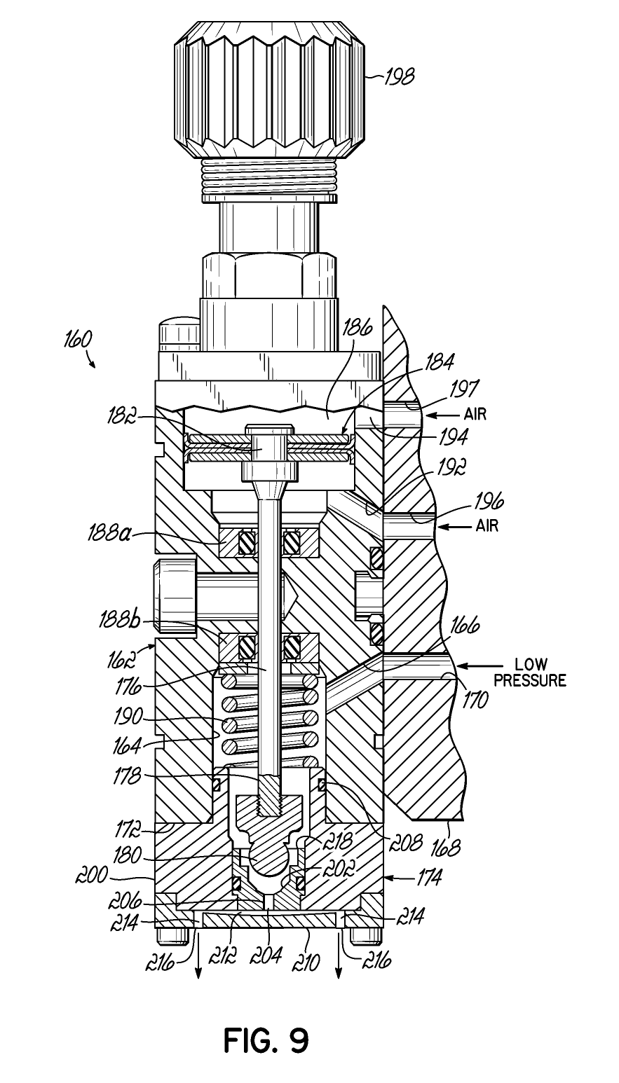

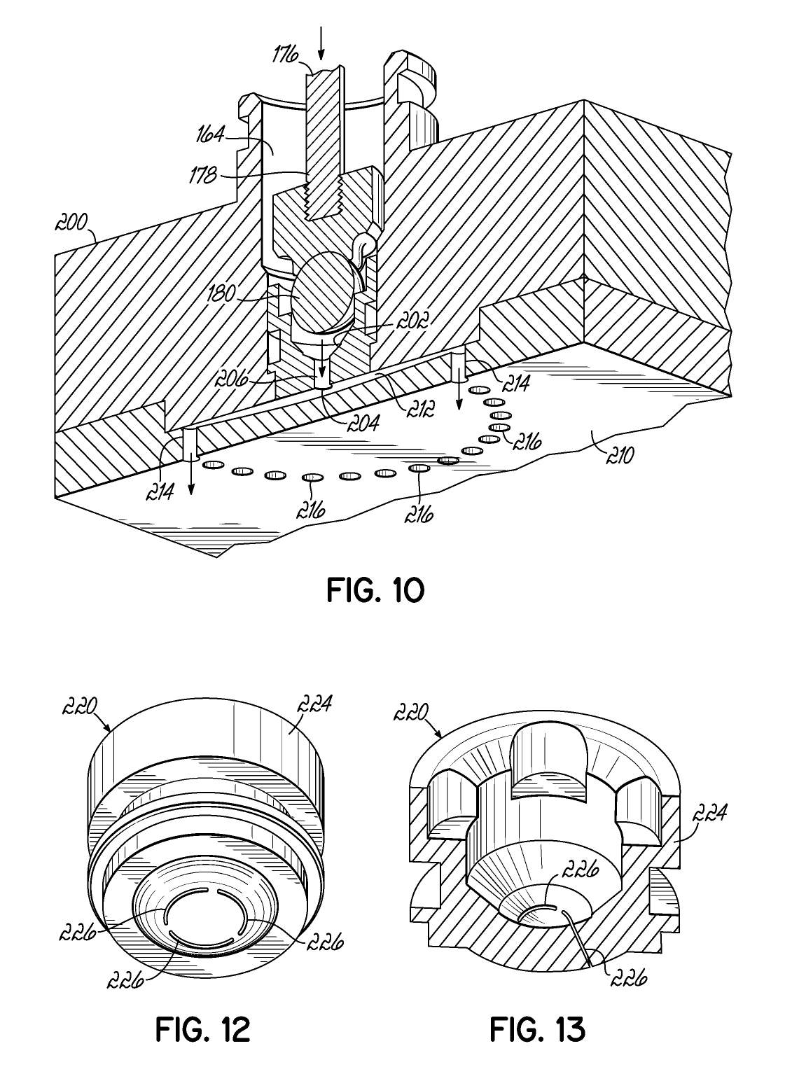

FIGS. 9-10 depict yet another exemplary jetting module 160 for jetting discrete volumes of liquid material in a desired pattern, such as a circular pattern. Referring now to FIGS. 9 and 10, the jetting module 160 includes a module body 162 having a liquid chamber 164 formed therein. A liquid supply passage 166 communicates with the liquid chamber 164 to supply liquid material to the liquid chamber 164 from an adhesive supply (not shown) through a manifold 168. In the embodiment shown, a liquid passageway 170 formed through the manifold 168 communicates with the liquid supply passage 166 of the module body 162, whereby liquid material flows from the liquid supply passageway 170, through the supply passage 166 of the module body 162, to the liquid chamber 164. In the embodiment shown, hot melt adhesive is supplied at low pressure (in the range of about 5 psi to about 40 psi) through liquid passageway 170 to the module 160. It will be appreciated that various other arrangements and configurations may alternatively be used to supply hot melt adhesive or other material to the module 160.

The module body 162 includes an open first end 172 communicating with the liquid chamber 164 and adapted to receive a nozzle 174. The jetting module 160 further includes a piston rod 176 having a first end 178 reciprocatingly movable within the liquid chamber 164. A piston tip 180 is coupled to the first end 178 of the piston rod 176. The second end 182 of the piston rod 176 is coupled to an air piston 184 that is slidably movable within a piston cavity 186 formed in the module body 162. Seals 188a, 188b disposed between the liquid chamber 164 and the piston cavity 186 permit sliding movement of the piston rod 176 while sealing the liquid chamber 164 from the piston cavity 186. A compression spring 190 biases seal 188b against module body 162 to seal liquid chamber 164 when nozzle 174 is coupled to the first end 172 of the module body 162. Pressurized air from an air source (not shown), is provided to the piston cavity 186 through air supply passages 192, 194 to rapidly move the air piston 184, and thus the piston rod 176 and the piston tip 180, in directions toward and away from the nozzle 174. In the embodiment shown, air supply passages 192, 194 are in fluid communication with air passages 196, 197 in the manifold 168, which are in turn operatively coupled with the air source. Pressurized air provided through air supply passage 192 drives the piston in a direction away from nozzle 174, while pressurized air provided through air supply passage 194 drives the piston in a direction toward nozzle 174. It will be appreciated that various other methods and configurations for providing pressurized air to the piston cavity 186 may alternatively be used. The module 160 further includes an adjustment knob 198 for selectively adjusting the stroke of the piston rod 176 to facilitate varying the volume of liquid material jetted by the module 160 for each cycle of the piston rod 176.

Nozzle 174 is coupled to the module body 162 at the open first end 172. The nozzle 174 includes a nozzle body 200 having a recess 202 formed in a shape that is complementary to the shape of the piston tip 180, whereby the piston tip 180 may be received within the recess 202. In the embodiment shown, the piston tip 180 is semi-spherical, and the recess 202 has a generally semi-spherical complementary shape. It will be appreciated, however, that nozzle tip 180 and recess 202 may have various other complementary shapes. The nozzle body 200 further includes an outlet 204 communicating with the recess 202 via a nozzle passageway 206, such that liquid material in the liquid chamber 164 is forced through the nozzle passageway 206 and nozzle outlet 204 when the piston tip 180 is received within the recess 202. Nozzle 174 may further include an O-ring 208 for sealing against module body 162 at the open first end 172.

A pattern plate 210 is coupled to the nozzle body 200, proximate the nozzle outlet 204. A recess formed in the pattern plate 210 forms a distribution channel 212 between the nozzle body 200 and pattern plate 210. The distribution channel 212 provides fluid communication between the nozzle outlet 204 and a plurality of outlet passages 214 formed through the pattern plate 210, through which liquid material is jetted from outlets 216 to a substrate in a desired pattern.

In operation, pressurized air is supplied to the piston cavity 186 through the air supply passage 192 to cause the piston rod 176 to move in a direction away from the nozzle 174, such that the piston tip 180 is withdrawn from the recess 202, whereby liquid material enters the fluid chamber 164 to fill the fluid chamber 164 and the recess 202. Liquid material is supplied through supply passage 166 from the manifold 168 at a pressure sufficient to fill the fluid chamber 164 and recess 202, but not to cause liquid material to be dispensed from the outlets 216 in pattern plate 210. Pressurized air is then supplied to the piston cavity 186 through the air supply passage 194 to cause the piston rod 176 to rapidly move the piston tip 180 in a direction toward the nozzle 174. As the piston tip 180 begins to enter the recess 202, the piston tip 180 substantially seals the recess 202 along an upper edge 218 to define a discrete volume of liquid between the piston tip 180 and the recess 202. It will be appreciated that there is some clearance between the piston tip 180 and the upper edge 218 of the recess 202 to permit the piston tip 180 to move into and out of the recess 202 without binding against the recess 202. As used herein, substantially sealing between the piston tip 180 and the recess 202 means that the clearance between the piston tip 180 and the upper edge 218 of the recess 202 is sufficiently small that liquid material is forced by the piston tip 180 to be displaced through the nozzle passageway 206 and nozzle outlet 204, rather than simply moving around the piston tip 180.

The piston rod 176 continues to move in a direction toward the nozzle 174 such that the piston tip 180 continues to enter the recess 202 and displaces the liquid material in the recess 202 through the nozzle passageway 206 and nozzle outlet 204. Because the piston tip 180 effectively seals recess 202 as described above, a discrete volume of liquid material is defined and high pressure is developed between the piston tip 180 and the recess 202 as piston tip 180 continues to enter the recess 202. The pressure generated may be in the range of about 400 psi to about 2500 psi. The discrete volume of liquid material is forced through the nozzle outlet 204 into the distribution channel 212 and through the outlet passages 214 to be jetted from outlets 216 in a desired pattern.

While operation of the module 160 has been described and illustrated in a manner wherein piston tip 180 becomes fully seated within recess 202 to dispense substantially the entire volume of liquid material within recess 202, it will be appreciated that the range of motion of piston 176 may alternatively be controlled such that piston tip 180 is not fully seated within recess 202 at the end of each stroke of piston 176, whereby an amount less than the entire volume of liquid material within recess 202 may be dispensed.

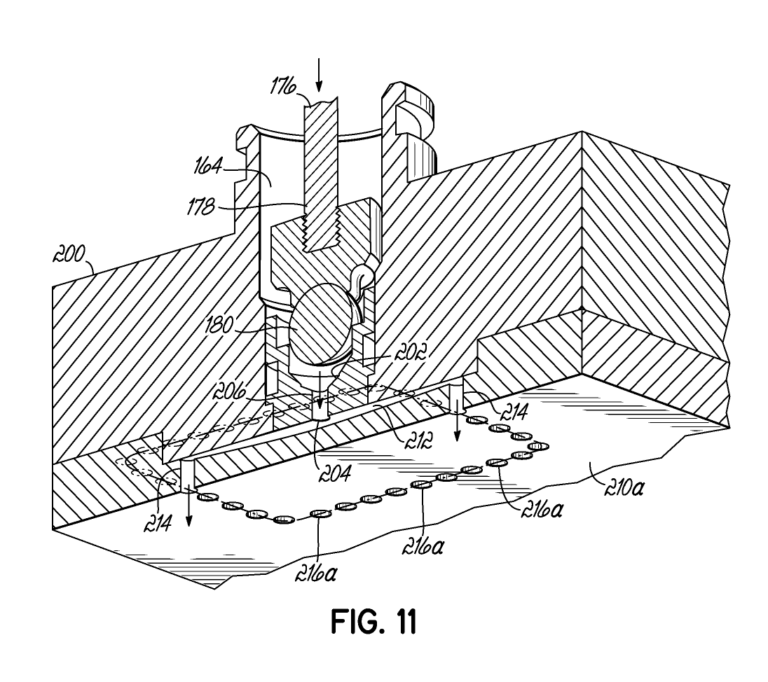

While the embodiment shown and described with respect to FIGS. 9-10 depicts a pattern plate 210 configured to jet liquid material in a generally circular pattern, it will be appreciated that liquid material may alternatively be jetted in various other patterns by appropriate modification of the pattern plate. For example, FIG. 11 depicts another exemplary jetting module, similar to the jetting module shown and described with respect to FIGS. 9-10, but wherein the pattern plate 210a comprises a plurality of outlets 216a arranged in a generally rectangular pattern.

While the jetting modules 160 of FIGS. 8-11 have been described above with pattern plates 210, 210a having one or more outlets 216, 216a arranged in desired patterns, jetting modules in accordance with the present disclosure may alternatively be configured to have outlets formed directly in a nozzle body for jetting liquid material in a desired pattern. In such embodiments, liquid material may be jetted in a desired pattern without the need of an additional pattern plate.

FIGS. 12-13 depict one exemplary embodiment of a nozzle 220 that can be used with the module 160 shown and described with reference to FIG. 9, wherein the nozzle body 224 includes one or more nozzle outlets 226 arranged and configured to jet liquid material in a desired pattern. In use, the module 160 operates as described above, however, liquid material is jetted directly from nozzle outlets 226 to a substrate. While FIGS. 12-13 depict an embodiment wherein nozzle outlets 226 are arranged and configured to jet liquid material in a generally circular pattern, it will be appreciated that various other patterns may alternatively be jetted.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. (canceled)

2. (canceled)

3. An apparatus for jetting liquid material in a desired pattern, comprising:
a dispenser body couplable to a source of liquid material, said dispenser body including a liquid chamber;
a piston movably disposed within said liquid chamber and having a piston tip;
a recess in fluid communication with said liquid chamber and with a liquid passageway, said recess shaped complimentary to said piston tip such that said piston tip is receivable within said recess;
said piston movable from a first position wherein said piston tip is spaced from said recess, to a second position wherein said piston tip effectively seals off said recess to define a discrete volume between said piston tip and said recess, then to a third position wherein said piston tip is received within said recess to displace said discrete volume from said recess through said liquid passageway; and
a pattern plate in communication with said liquid passageway, said pattern plate including at least one liquid outlet defining the desired pattern of the liquid material.

4. The apparatus of claim 3, wherein said pattern plate includes a plurality of liquid outlets arranged to correspond generally to the desired pattern.

5. A method of dispensing liquid material in a desired pattern, comprising:
supplying liquid material to a liquid chamber at a pressure sufficient to fill the liquid chamber, but not to dispense the liquid material from the liquid chamber;
effectively sealing off a discrete volume of liquid material proximate the recess; and
generating a high pressure at the recess after effectively sealing off the discrete volume to thereby jet the discrete volume of liquid material from at least one outlet in the desired pattern of liquid material.

6. The method of claim 5, wherein liquid material is jetted from a plurality of outlets arranged to define the desired pattern of dispensed liquid material.

7. The method of claim 5, wherein the pressure generated is in the range of about 400 psi to about 2500 psi.

8. The method of claim 5, wherein generating a high pressure at the recess comprises rapidly moving a piston over a short distance.

9. The method of claim 5, wherein the discrete volume of liquid material is jetted as a plurality of individual volumes of liquid material.

10. The method of claim 9, further comprising coalescing the individual volumes to form a unitary pattern.
